(19) United States
(12) Patent Application Publication
(10) Pub. No.: US 2008/0123956 A1
(43) Pub. Date: May 29, 2008

(54) Active environment scanning method and device

(75) Inventor: Andrei Cernasov, Ringwood, NJ (US)

Correspondence Address: Kurt Luther;HONEYWELL INTERNATIONAL INC., Law Department AB 2, P.O. Box 2245, Morristown, NJ, 07962-9806, US

(73) Assignee: HONEYWELL INTERNATIONAL INC.

(21) Appl. No.: 11/604,797

(22) Filed: Nov. 28, 2006

(51) Int. Cl. G06K 9/34

(52) U.S. Cl. 382/173

(57) ABSTRACT

Methods and apparatuses are used for segmenting a viewing environment of an image display device (80) into angular regions based on the current positioning of viewers. Image data of the viewing environment may be captured and analyzed to detect possible regions (400) exhibiting the red-eye effect. These regions may be paired off, and each pair may be verified as corresponding to a viewer's eyes based on whether they exhibit the characteristics of blinking.

### BACKGROUND OF THE INVENTION

1. Field of the Invention

The present invention relates to image display, and more particularly, to techniques for mapping an angular viewing area of an image display panel according to viewer position.

2. Description of the Related Art

It is contemplated that image display panels may be designed for enhanced operation based on a detailed knowledge of the viewer's position.

For example, it is contemplated that an image display panel could display three-dimensional (3D) images, without requiring the user to wear special 3D glasses, as described in copending U.S. patent application Ser. No. ______ (Docket No. H00011896), entitled “Directional Display,” filed on the same date and by the same inventor as the present application, the entire contents of which are incorporated herein by reference. This application describes a display panel designed to create a 3D visual effect by precisely aiming different images toward the left and right eyes, respectively, of a viewer. It would be beneficial for such a device to be capable of tracking the precise location of the viewer's eyeballs, so that 3D images are displayed even if the viewer moves within the viewing environment.

However, there are other ways that image display could be enhanced based on knowledge of the precise location of the viewer(s). For instance, it is contemplated that different types of information could be displayed to the viewer based on his/her position in the viewing environment. An example of this is to display location-based information prompting the viewer to move toward a desired location within the viewing environment (e.g., closer to the center). This type of display might be useful in applications where the subject is to be photographed for security, professional portrait, etc.

A camera might be used to identify and track the position of a viewer's eyes using conventional image recognition techniques, which involve video digital signal processing (DSP) procedures. However, such techniques are time consuming and computationally expensive, because they require mathematical transformations of image frames and other types of image processing to account for illumination conditions, etc.

### SUMMARY OF THE INVENTION

Disclosed embodiments of this application are used for segmenting the viewing environment of an image display panel into angular regions, which correspond to the current positions of the people viewing the display panel.

Particularly, the present invention identifies and tracks pairs of eyes associated with people in the viewing environment. To do this, exemplary embodiments of the invention detect occurrences of the “red-eye” effect in people who are viewing the display panel. Thus, the present invention may include a mechanism (light source) for creating the red-eye effect in the viewers and an image capture device for obtaining image data of the environment. The captured image data may be analyzed to find occurrences of red-eye and, thus, identify the position of a viewer in the display panel environment.

Although the red-eye effect is more commonly associated with flash photography (i.e., in the visible spectrum), the red-eye effect also occurs in the infrared (IR) spectrum. Thus, an embodiment of the present invention may create the red-eye effect by emitting IR light into the room, so as not to interfere with normal viewing of the images. Further, image data of the environment may be captured by an IR camera and analyzed to detect occurrence of red-eye.

In an exemplary embodiment of the invention, the captured image data is analyzed to confirm potential red-eye regions as corresponding to the eyes of a viewer. This may be accomplished by applying a “blink filter.” Specifically, after potential red-eye regions are paired off, the blink filter analyzes each pair of red-eye regions to determine whether they disappear and reappear simultaneously in accordance with the normal eye blinking of a user. Thus, each blinking pair of red-eye regions is confirmed to be a pair of viewer's eyes.

In a further embodiment, the location of each pair of eyes detected from the captured image data may be mapped to a particular angular region in the viewing embodiment. For example, each eye of each viewer may be mapped to a particular angular region. Furthermore, this map may be used for driving the image display operation of an image display panel. For example, if the display panel is specially configured for precise directional display, the map may be used for creating a three-dimensional (3D) visual effect by directing slightly different images to the viewer's left and right eyes.

### BRIEF DESCRIPTION OF THE DRAWINGS

Further aspects and advantages of the present invention will become apparent upon reading the following detailed description in conjunction with the accompanying drawings, which are given by way of illustration only and, thus, are not limitative of the present invention. In these drawings, similar elements are referred to using similar reference numbers, wherein:

FIG. 1 is a functional block diagram of a system for active scanning of the viewing environment of an image display panel, according to an exemplary embodiment of the present invention;

FIG. 2 illustrates the detection of viewer positions in the viewing environment of an image display panel, according to an exemplary embodiment of the present invention;

FIGS. 3A-3D is a flow diagram illustrating operations performed by a control unit in the system illustrated in FIG. 1, according to an exemplary embodiment of the present invention;

FIGS. 4A and 4B illustrate aspects of the operation of searching for paired eye signatures, according to an exemplary embodiment of the present invention;

FIG. 5 illustrates a map of the viewing environment of a display panel, in which the angular space is segmented into regions corresponding to the positioning of viewers, according to an exemplary embodiment of the present invention; and

FIG. 6 illustrates the sequential processing of a frame of IR image data to facilitate the detection of red-eye regions, according to an exemplary embodiment of the present invention.

### DETAILED DESCRIPTION

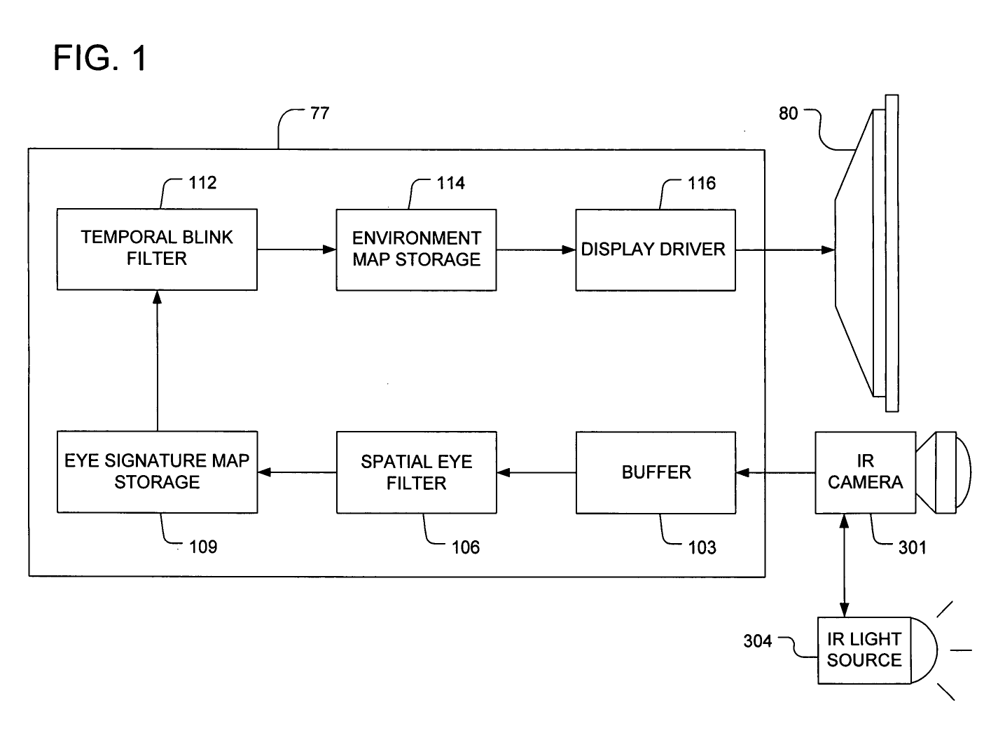

Aspects of the invention are more specifically set forth in the accompanying description with reference to the appended figures. FIG. 1 is a functional block diagram of a system for active scanning of the viewing environment of an image display panel, according to an exemplary embodiment of the present invention. As shown in FIG. 1, the system includes a display panel 80, a control unit 77, and an infrared (IR) camera 301.

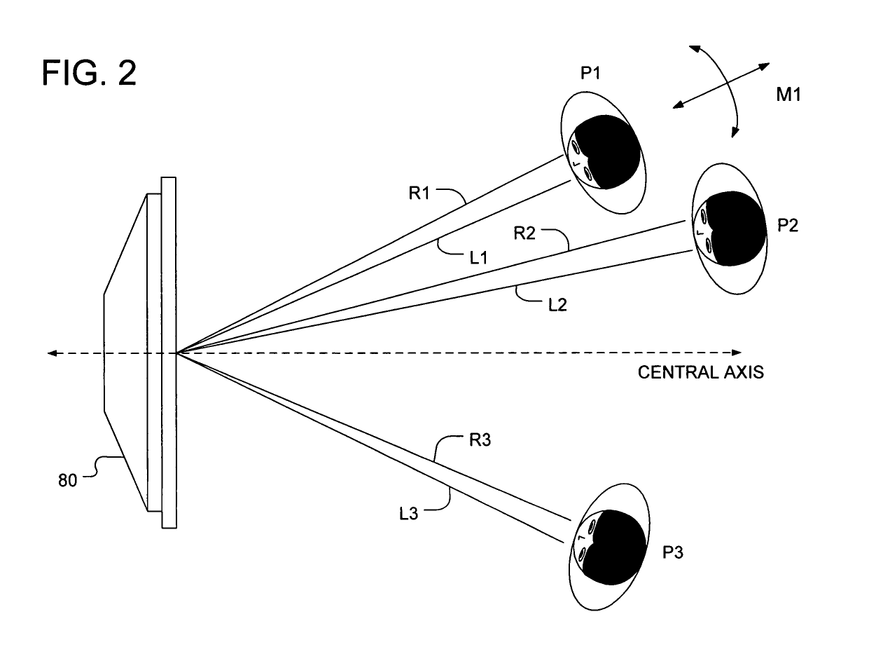

As illustrated in FIG. 1, the control unit 77 includes the following functional units: an image buffer 103, a spatial eye filter 106; a memory unit for storing eye signature map 109; a temporal blink filter 112, a memory unit for storing a map of the viewing environment 114, and a display driver 116. The control unit 77 may be connected to a display panel 80, an infrared (IR) camera 301 (or other type of image capture device), and an IR light source 304 (or, possibly, a visible flash source). It should be noted that FIG. 1 is merely a functional block diagram and is not meant to show the physical positioning or configuration of element illustrated therein. For example, to help ensure effective operation, the IR camera 301 may be physically aligned with a central axis of the display panel 80 (illustrated in FIG. 2).

The control unit 77 of FIG. 1 identifies positions of viewers in the viewing environment of the display panel. The control unit 77 may use this information to drive an image display panel 80, via display driver 116.

For instance, if the display panel 80 is configured for precise directional display (as will be described in more detail below), the display driver 116 may control the display panel 80 to generate various images and aim them directly to specific viewers. Thus, the display panel 80 may be configured to display different images to different viewers, based on their positions. Also, in an exemplary embodiment, the control unit 77 may be capable of detecting the precise locations of each eye of the viewer. Thus, by controlling the display panel 80 to aim slightly different images to the viewer's left and right eyes, respectively, the viewer may be able to view three-dimensional (3D) images without needing to wear special eyeglasses or other headgear (as will be described in more detail below).

Referring again to FIG. 1, the control unit 77 may include any combination of electrical systems, mechanical systems, electronic systems, etc., for the purpose of detecting the positions of viewers of the display panel 80, and mapping these positions to an angular space of the viewing environment, according to principles of the invention described hereinbelow. Although one embodiment contemplates a display panel 80 specially designed for directional display, the display panel 80 is not thus limited. According to alternative embodiments, the present invention may be used with any type of display 80 including, for example, liquid crystal displays (LCDs), desktop displays, handheld displays, theatre screens, etc.

However, as described above, the display panel 80 may be configured as a directional display, capable of generating images and aiming them in different programmable directions in the viewing environment. Examples of directional display panels 80 are described in copending U.S. patent application Ser. No. ______ (Docket No. H00011896), entitled “Directional Display,” filed on the same date and by the same inventor as the present application, the entire contents of which are incorporated herein by reference. Particularly, as described in detail in the aforementioned copending patent application, a directional display panel 80 may include microscopically small light deflecting devices corresponding to respective pixel positions. Each light deflecting device may be selectively switched between different states for precisely deflecting light (image pixel) in different directions, under the control of electrical, mechanical, and/or magnetic signals. For instance, the light deflecting devices may be implemented using existing Digital Micromirror Device™ (DMD) technology, manufactured by Texas Instruments, or using microfluidic devices described in more detail in the aforementioned copending patent application.

For embodiments in which the display panel 80 is a directional display, it is possible to display 3D images to each viewer. Thus, a concise description of 3D images will now be provided. When viewing an object in a room, e.g., the 3D effect is created because the viewer's left eye is seeing something different than the right eye at a particular moment. Specifically, when a person looks at the object, the left eye forms a left-eye image I_{L} of the object and the right eye forms another, slightly different, right-eye image I_{R} of the object. The differences between the left-eye image I_{L} and right-eye image I_{R} can be seen by looking at an object with the left eye while the right eye is covered, and then with the right eye while the left eye is covered. Both images I_{L} and I_{R} are sent to the viewer's brain, and the brain processes them in order to obtain a 3D image of the object.

Thus, if display panel 80 is a directional display, it may be capable of mimicking the effect of left and right eye imaging by generating two separate images I_{L} and I_{R} to be sent to the viewer's left and right eyes, respectively, using eye positioning information mapped by the control unit 77. If the images I_{L} and I_{R} are transmitted to the respective eyes at nearly the same time, the viewer's brain will process them to create the 3D effect.

The above description of directional displays and 3D imaging applications is only provided for the purpose of enablement of a particular embodiment. Such description is not meant to limit the present application to the use of directional displays or the application of displaying 3D images.

Referring again to FIG. 1, the control unit 77 may identify and map the positions of viewers in the viewing environment, even as they move. Reference will now be made to FIG. 2 to help explain this operation. Specifically, FIG. 2 illustrates an exemplary viewing embodiment of a display panel 80 in which three viewers P1, P2, and P3 are present. For purposes of the invention, the control unit 77 (not shown in FIG. 2) may detect the position of each person's P1, P2, P3 eyes as angular positions with respect to the central axis. Thus, in FIG. 2, the location of the right and left eyes of viewers P1, P2, and P3, are respectively illustrated by rays R1, L1, R2, L2, R3, and L3, each beam having an associated angle with respect to the central axis.

As described above, the control unit 77 may identify eye positions of the eyes of viewer P1, P2, and P3, while viewers move within the environment. Since the control unit 77 may track position in terms of angular position, FIG. 2 illustrates a frame of reference M1 according to which the control unit 77 will “see” this movement.

Referring again to FIG. 1, the control unit 77 may additionally include functional unit(s) for performing necessary calculations or data processing for determining the angular positions of each viewer's eyes, based on the detected occurrences of red-eye in the viewing environment. Also, the control unit 77 may include any functional unit(s) necessary for using such information to generate a map of the angular space in the viewing environment to be stored in the memory unit 114. This mapping of the environment may be used for various applications. For example, it may be used simply to track certain types of information, e.g., the number of viewers viewing a particular television program, a qualitative and quantitative description of movement by viewers in the embodiment, etc.

Alternatively, by dynamically tracking the current position and number of viewers, the display panel 80 may be designed to display images tailored to such information. For example, such an application may be used for prompting a viewer to move toward a desired location within the viewing environment (e.g., closer to the center). This might be useful in applications in which the subjects are to be photographed for security, professional portrait, etc. Another use might be to wait until a predetermined number of viewers are present before starting a movie or television program. Also, if the display panel 80 is a directional display, the mapping of the viewing environment could be used for displaying 3D images (described above) or for displaying different types of data to viewers at different locations.

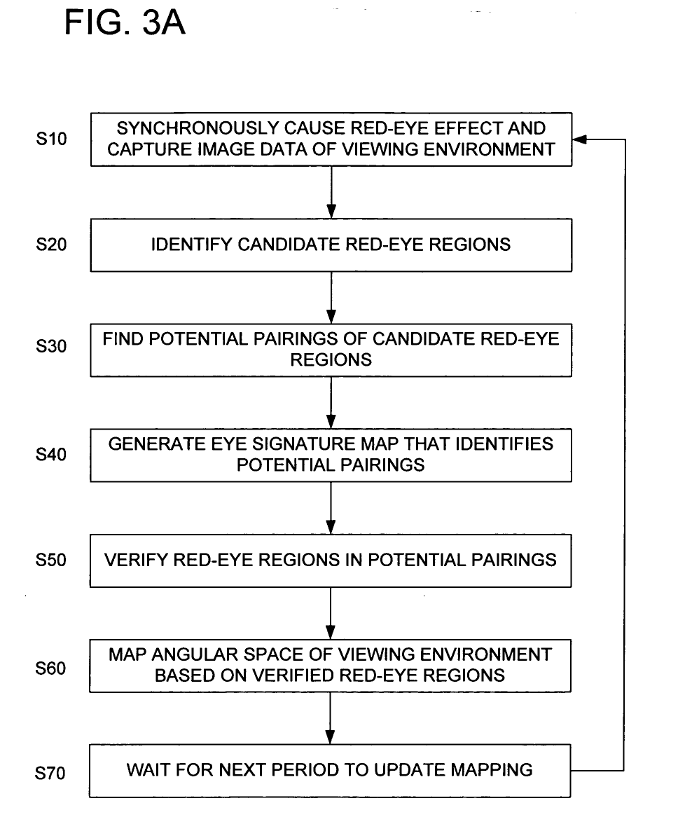

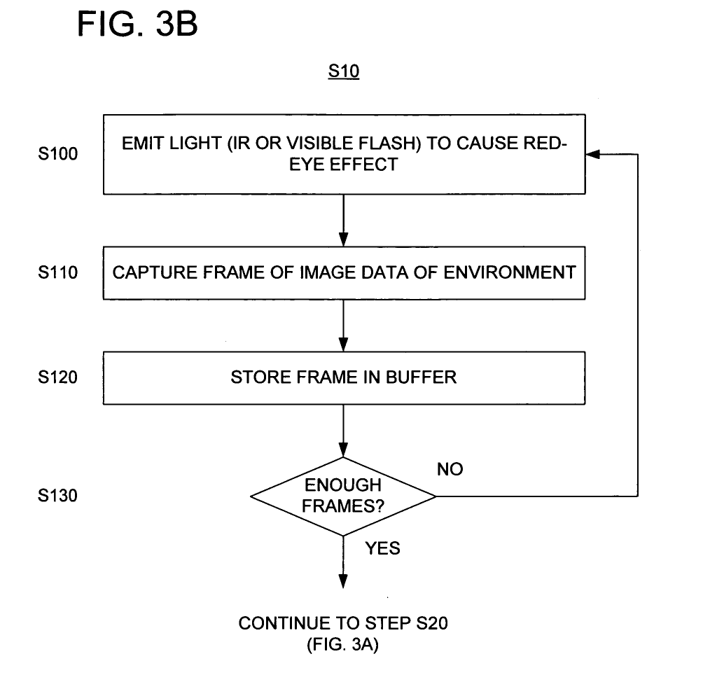

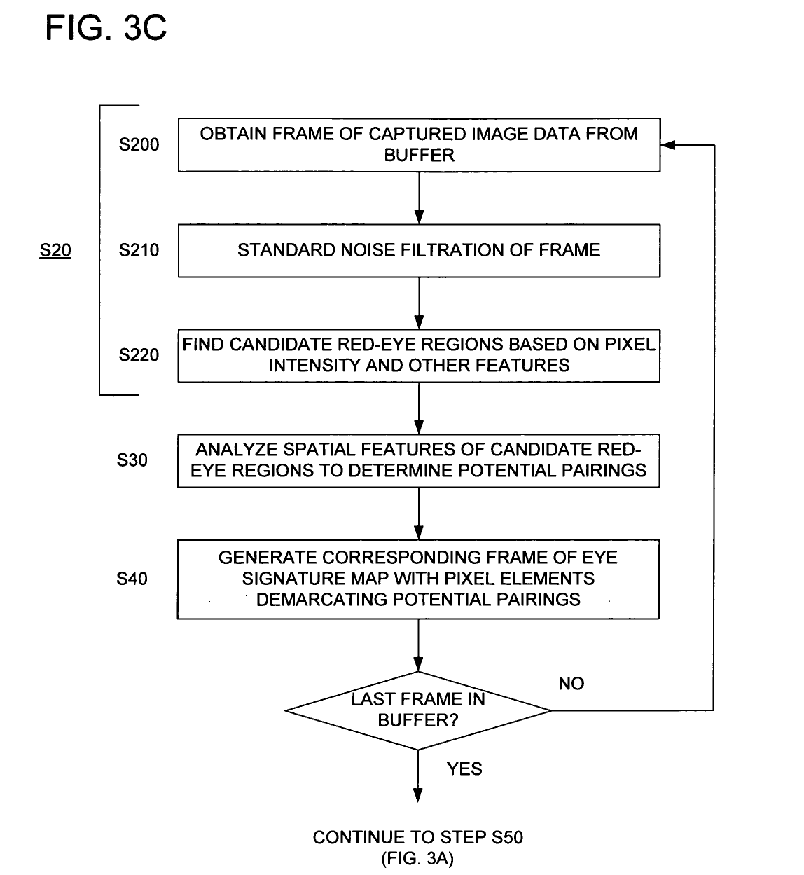

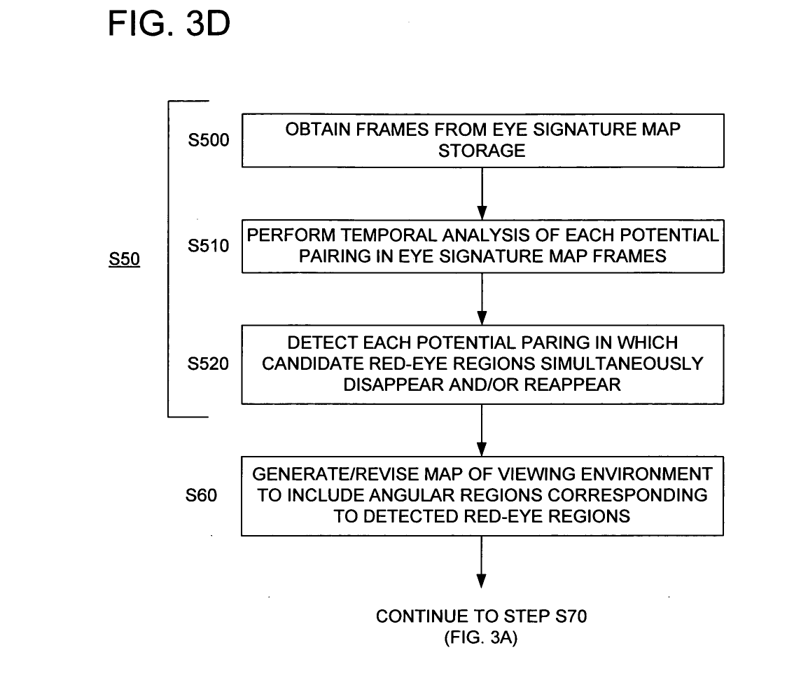

Now, the operation of the control unit 77 and other components of the system illustrated in FIG. 1 will be described. To help explain this operation, reference will be made to FIGS. 3A-6 in the following description.

Particularly, FIG. 3A is a flowchart illustrating a high-level operation of the components in the system of FIG. 1. FIGS. 3B-3D are flowcharts providing a more detailed description of steps in FIG. 3A. Thus, the following description will refer to steps shown in FIGS. 3A-3D.

According to an exemplary embodiment, the control unit 77 implements a method for individual eye detection using the red-eye effect. The red-eye effect refers to the reflection of light off the retinas at the back of a person's eyes. This commonly occurs in flash photography, where the photographed person's eyes do not have time to adjust to the sudden brightness before the picture is taken. Thus, the person's eyes appear red in the photograph. However, the red-eye effect is present in both visible and infrared (I_{R}) regions of the spectrum. Thus, it is possible for the present invention to use the red-eye effect in either visible or in infrared, to detect positions of viewers' eyes.

However, it might be preferable to take advantage of the IR red-eye effect, which does not require the flashing of visible light that would otherwise interfere with the viewing of the image. Accordingly, in an exemplary embodiment, the control unit 77 uses the IR red-eye effect to perform a quick and computationally inexpensive mapping of the angular viewing area of display 80, without being noticed by the viewers.

While the red-eye effect is being created in the eyes of viewers in the viewing environment, image data of the viewing environment is captured in real-time by camera 301. This is illustrated in step S10 of FIG. 3A.

FIG. 3B provides a more detailed illustration of step S10. In one embodiment, the red-eye effect may be caused by the emission of light from light source 304 into the viewing environment (step S100 in FIG. 3B). For instance, in an embodiment using the IR red-eye effect, an I_{R} light source 304 may continuously emit IR light into the viewing environment. The IR light does not have to be flashed because, since it is invisible to the viewers, the viewers' eyes will not adjust to the IR light in such a manner that removes the red-eye effect. Alternatively, if a visible red-eye effect were used, the light source would have to periodically flash to repeatedly cause the red-eye effect in viewers' eyes.

As the light is emitted by source 304, the camera 301 (e.g., IR camera) captures image data of the viewing environment (step S110 in FIG. 3B). The frames of the viewing environment image data may be stored in a partial or full-frame image buffer 103 (step S120). To help ensure proper operation, the camera 301 may be physically aligned with the central axis of the display panel 80, so that camera 301 captures the image data according to the same frame of reference as the display panel 80. The image buffer 103 may (but does not have to) include a central processor that stores environment viewing data for easy access, a central memory and other memory units storing image reference information, magnetic or optical storage media, etc.

The camera 301 should be controlled to capture enough image frames so that the red-eye regions can be distinguished from other image elements. This is illustrated in step S120 of FIG. 3B. For instance, the red-eye regions may be distinguished based on a temporal analysis of the image data, as will be described in more detail below.

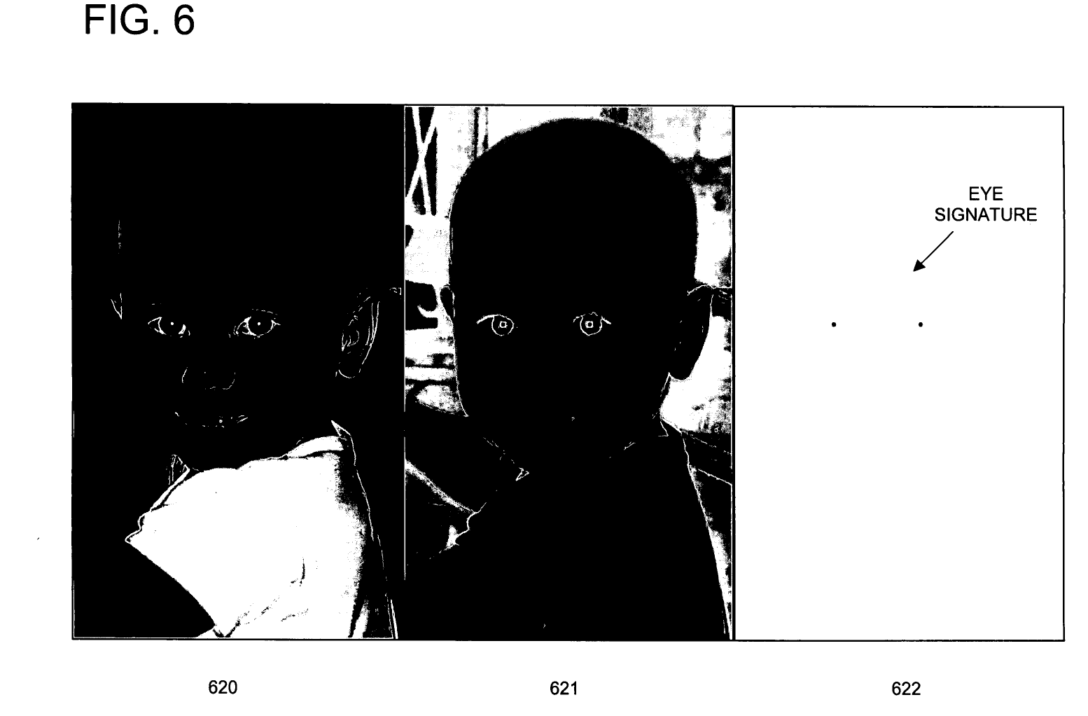

As illustrated by steps S20-S40 of FIG. 3A, the control unit 77 identifes candidate red-eye regions in the captured image data of the environment (S20), finds potential pairings of these candidate red-eye regions (S30), and generates an eye signature map to identify or demarcate these potential pairings (S40). FIG. 3C is a flowchart describing these steps in further detail. Also, FIG. 6 illustrates a simplified example of applying these steps to an image of a single person.

Particularly, the control unit 77 may obtain each frame of the captured image data and apply standard noise filtration on the image frame (steps S200 and S210 in FIG. 3C). An example of this image frame is illustrated as 620 in FIG. 6. After filtration, the control unit 77 may process the frame data to find candidate red-eye regions in the frame (step S220 in FIG. 3C).

If IR image data is captured, the red-eye pixel clusters may appear as bright (nearly white) spots in the image data. Thus, in an exemplary embodiment, the intensity values of the filtered image frame may be inverted, as illustrated by frame 621 of FIG. 6.

Thus, the spatial eye filter 106 may identify and tags pixel clusters of a particular color and/or intensity level. Other criteria may also be applied to such pixel clusters, i.e., only those pixel clusters and having a contiguous area within an expected size and/or shape may qualify as a candidate red-eye region. The criteria for color, intensity, sizes and/or shape, may be determined, e.g., by off-line training using a large number of face images exhibiting red-eye effect.

The control unit 77 may also use various criteria, as well as different types of feature recognition technologies, to detect candidate red-eye regions. Such feature recognition technologies may use, e.g., neural-network techniques, Principal Components Analysis based techniques, etc.

After the candidate red-eye regions are found, the spatial filter 106 may process the candidate eye regions in the image data. Specifically, the spatial filter 106 attempts to find a potential pairing of each candidate red-eye region with another (step S30 in FIGS. 3A and 3C). The reason for this is simple—viewers' eyes come in pairs. Thus, to find pairings of candidate red-eye regions, which correspond to pairs of viewers' eyes, the spatial filter 106 may look for pairs that satisfy various spatial criteria. For instance, a viewer's eyes are generally at the same vertical level (i.e., on the same horizontal axis). Thus, candidate red-eye regions in a potential pairing should be on the same horizontal axis in a captured image frame. Also, each of the viewer's eyes will generally exhibit the same size and shape of red-eye. Also, there will generally be limits on how far apart a viewer's eyes will appear in a captured image (depending on how far the viewers are expected to be from the camera 301).

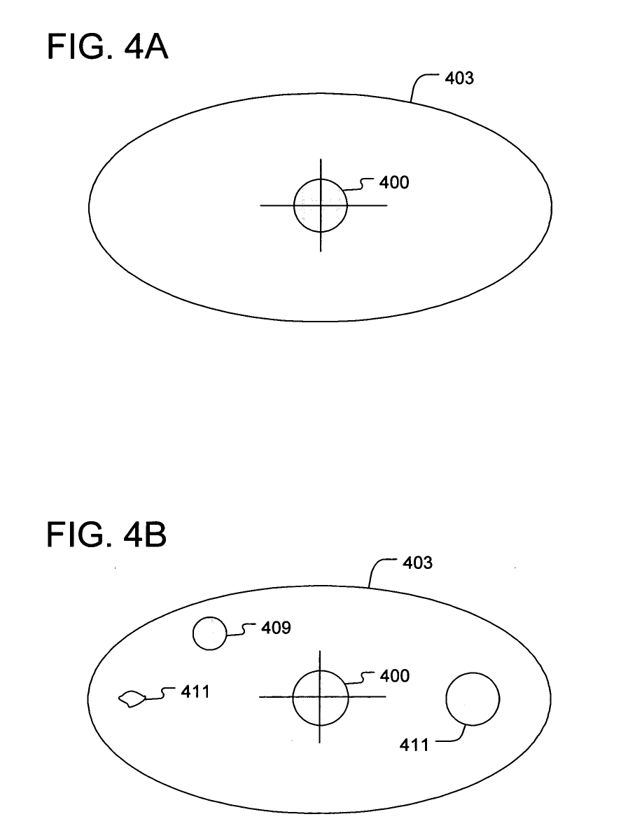

FIGS. 4A and 4B illustrate how these criteria may be applied by the spatial filter 106 to search for potential pairings. The spatial filter 106 may perform a search for each candidate red-eye region 400 for another candidate with which to be paired. As shown in FIG. 4A, the search may be limited to a particular search frame 403 for the candidate red-eye region, ensuring that the potential pairings are within a certain distance. FIG. 4B illustrates an example of different candidate red-eye regions that might be found within the search frame 403. Since candidate region 409 is not close to the same horizontal axis as candidate region 400, they may be rejected as a potential pairing by the spatial filter 106. Similarly, since the candidate region 411 has a different shape than candidate region 400, they also may be eliminated by the spatial filter. However, since candidate region 406 is on the same horizontal axis, and has the same general size and shape, as candidate region 400, the spatial filter may determine that candidate red-eye regions 400 and 406 comprise a potential pairing.

Of course, spatial filter 106 may apply other criteria to determine potential pairings, e.g., similar pixel intensity or color, etc.

As potential pairings of candidate red-eye regions are determined for each frame of the captured image data, the control unit 77 may generate a corresponding frame of an eye signature map in which the potential pairings are demarcated. This is illustrated in step S40 of FIGS. 3A and 3C.

As shown in FIG. 3C, the eye signature map may be generated on a frame-by-frame basis in accordance with the capture image data. For instance, each frame of the eye signature map may merely include a set of pixel elements demarcating the potential pairings of candidate red-eye regions, as illustrated in frame 622 of FIG. 6. The control unit 77 may store the eye signature map frames in memory unit 114.

After each of the buffered frames of image data have been processed in order to generate the eye signature map, the control unit 77 may verify whether each potential pairing of candidate red-eye regions actually correspond to a pair of viewer's eyes. This is shown in step S50 of FIG. 3A. In particular, the temporal blink filter 112 in FIG. 1 may perform a temporal analysis on the frames of the eye signature map in order to perform this verification.

FIG. 3D illustrates further details on the process performed by the temporal blink filter 112 in steps S500, S510, and S520. Particularly, the frames of the eye signature map are obtained from storage in memory unit 109 (step S500). These frames are used for performing a temporal analysis on each potential pairing identified in the eye signature map (step S510). In particular, the temporal blink filter 112 determines whether the candidate red-eye regions within each potential pairing “blinks,” i.e., disappears and reappears in unison, within the time duration represented by the frames of captured image data (step S520). To make this determination, the temporal blink filter 112 may merely seek out a simultaneous disappearance or reappearance to detect a blink for the potential pairing, or alternatively, may look for both a disappearance and reappearance to detect a blink. Furthermore, the temporal blink filter 112 may be designed to verify a potential pairing as actual red-eye regions after one detected blink, or more than one detected blink.

Since the potential pairings are verified as red-eyes based on blinking, the camera 301 should be designed to capture image data of the viewing environment over a long enough time period, such that each viewer will be expected to blink at least once during this time period. Accordingly, this is one criterion for determining whether the camera 301 has captured enough image frames, referring back to step S130 in FIG. 3B.

As discussed above, the temporal blink filter 112 verifies whether each potential pairing of candidate red-eye regions in the eye signature map actually corresponds to the eye positions of a viewer. Thus, for each verified set of red-eye regions, the control unit 77 extracts information about the positions of the corresponding eyes so that they can be mapped to the viewing environment.

For example, the control unit 77 performs the necessary calculations, mathematical transformations, etc. on the pixel elements in the signature eye map, demarcating a verified pair of red-eyes, to determine the angular position of each of the red-eyes with respect to the central axis. It will be readily understood by those of ordinary skill in the art the various techniques for deriving such information from the eye signature map.

Accordingly, the control unit 77 may be designed to segment the angular space of the viewing environment based on the detected positions of the viewers (specifically, their eyes). To do this, the control unit 77 may generate a map (or, alternatively, revise an existing map) of the viewing environment indicating the angular regions of the environment that correspond to the positions of each viewer's eyes. This is illustrated in step S60 of FIGS. 3A and 3D. This map may be stored in memory unit 114 to be accessed, as necessary, by the display driver 116 and/or other components/devices based on the particular application.

The control unit 77 may be configured to periodically repeat the procedure for mapping the location of viewers eyes, described above in connection with FIGS. 3A-3D. This would allow the map of the viewing environment to be updated regularly with the current position of the viewers and their eyes.

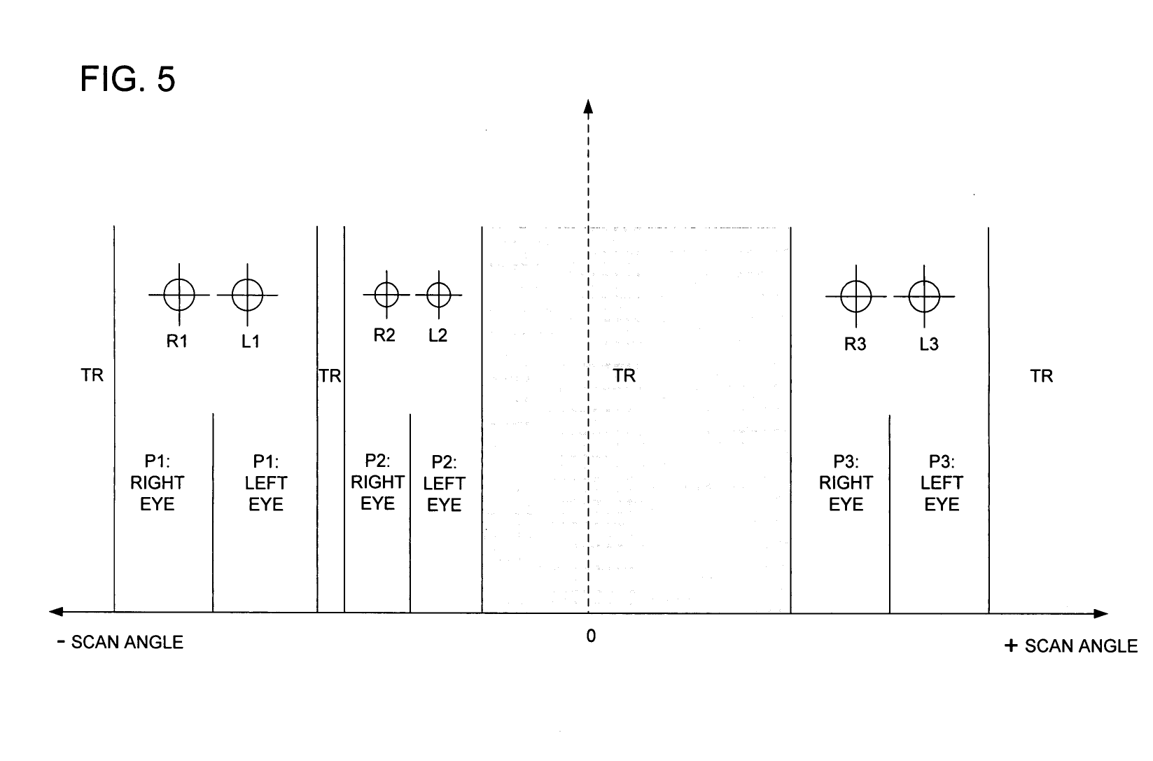

FIG. 5 conceptually illustrates a map of the viewing environment of a display panel 80, in which the angular space is segmented into regions corresponding to the positioning of viewers, according to an exemplary embodiment. Particularly, FIG. 5 illustrates an example in which the exemplary viewing environment of FIG. 2 is mapped.

Particularly, FIG. 5 shows the mapping of detected red-eye regions corresponding to the eye positions R1, L1, R2, L2, R3, L3 for viewers P1-P3. Accordingly, angular regions are defined, respectively, for the left and right eyes of viewer P1. Similarly, angular regions are defined for the left and right eyes of viewer P2, and for the left and right eyes of viewer P3. Also, as shown in FIG. 5, transition regions TR may be mapped for the viewing embodiment. These transition regions TR are regions of the viewing environment in which no viewer's eyeballs were detected.

Consider, for example, an application in which the display driver 116 in FIG. 1 controls a directional display panel 80 to display 3D images. In this application, the display driver 116 may control display panel 80 to display separate images I_{R} and I_{L} to the left and right eyes of each viewer P1, P2, P3. Thus, in accordance with the map of FIG. 5, the display driver 116 may control the display panel 80 to transmit pixels of right-eye image I_{R} toward the right-eye angular regions for viewers P1-P3, and to transmit pixels of left-eye image I_{L} to the left-eye angular regions for viewers P1-P3. Further, the display panel 80 may be controlled to transmit a “transition pattern” image toward the transition regions TR defined in the map. Specifically, this transition pattern may be a non-3D average of the right- and left-eye images I_{R} and I_{L}. The purpose of the transition pattern images would be to minimize the effects of a fast moving viewer in a crowded environment.

Further details regarding the specific control and operation of a directional display panel 80 are provided in copending U.S. patent application Ser. No. ______ (Docket No. H00011896), entitled “Directional Display,” filed on the same date and by the same inventor as the present application, the entire contents of which are incorporated herein by reference.

Referring again to FIG. 1, it should be noted that this figure is provided for illustration and is not intended to be limiting. Thus, the present invention contemplates various modifications, as will be contemplated by those of ordinary skill in the art. For instance, camera 301 may be replaced by any type of image capture device that captures, and stores/communicates images in IR, visible, or other radiation frequency spectrum.

Furthermore, although various components of FIG. 1 are illustrated as discrete components, they are intended to represent functional units, rather than separate physical devices. These functional units may be implemented using any known combination of hardware, software, and firmware. Thus, it will be readily apparent that the same physical device may be designed to perform the functions and operations of multiple units in FIG. 1 described above. Furthermore, it is possible that the functions associated with a single functional unit in FIG. 1 will be implemented using multiple discrete physical devices.

With various exemplary embodiments being described above, it should be noted that such descriptions are provided for illustration only and, thus, are not meant to limit the present invention defined by the claims below. The present invention is intended to cover any variation or modification of these embodiments, which do not depart from the spirit or scope of the present invention.

For example, although some aspects of the methods and apparatuses disclosed in this application have been described in the context of eye detection, it is contemplated that the principles disclosed in this application might be used for detection and tracking of other objects besides eyes of viewers.

Also, the principles of the present invention are applicable and can be incorporated in a variety of imaging systems and projective displays. The methods and apparatuses disclosed in this application may be implemented in LCDs, light-boxes, backlit advertising panels, theatre screen displays etc.

I claim:

1. A method comprising:
segmenting a viewing environment of an image display panel into angular regions according to a current positioning of one or more viewers of the image display panel.

2. The method of claim 1, further comprising:
capturing image data of the viewing environment; and
detecting red-eye regions in the captured image data that correspond to the current positioning of the one or more viewers.

3. The method of claim 2, further comprising:
emitting infrared (IR) light into the viewing environment,
wherein the captured image data is IR image data, and the detected red-eye regions are created as a result of the emitted IR light.

4. The method of claim 3, wherein the captured image data includes a set of image frames captured while the IR light is emitted.

5. The method of claim 2, wherein detecting the red-eye regions includes:
finding candidate red-eye regions in the captured image data based on pixel color or intensity;
creating an eye signature map of the captured image data identifying each potential pairing of candidate red-eye regions; and
analyzing the eye signature map to detect the candidate red-eye regions that correspond to the current positioning of the one or more viewers.

6. The method of claim 3, wherein the captured image data includes a set of image frames captured by an infrared (IR) camera while the IR light is emitted.

7. The method of claim 6, wherein finding candidate red-eye regions in the captured image data includes
finding pixel clusters in the captured image data having a predetermined color or level and having a size or shape that satisfies a predetermined criterion.

8. The method of claim 6, wherein potential pairings of candidate red-eye regions are determined by searching for candidate red-eye regions, which are on the same horizontal axis and have a predetermined spatial relationship with respect to each other.

9. The method of claim 6, wherein the eye signature map is generated frame by frame based on the captured image data, such that each frame of the eye signature map contains pixel elements demarcating the candidate red-eye regions in the corresponding frame of the captured image data that are part of a potential pairing.

10. The method of claim 9, further comprising:
performing a temporal analysis is performed on the eye signature map to detect each potential pairing in which the candidate red-eye regions simultaneously disappear, thereby detecting a pair of red-eye regions corresponding to a particular viewer's left and right eyes, respectively.

11. The method of claim 10, further comprising:
generating a map of the angular space in the viewing environment such that, for each detected pair of red-eye regions, the map is segmented into:
a first segment corresponding to the angular region of the viewing environment in which the particular viewer's right eye is positioned, and
a second segment corresponding to the angular region of the viewing environment in which the particular viewer's left eye is positioned.

12. The method of claim 11, further comprising:
using the map to direct first and second images from the image display panel toward the angular regions of the particular viewer's right and left eyes, respectively, in order to create a three-dimensional visual effect for the particular viewer.

13. An apparatus configured to:
segment a viewing environment of an image display panel into angular regions according to a current positioning of one or more viewers of the image display panel.

14. The apparatus of claim 13, comprising:
an image capture device configured to capture image data of the viewing environment; and
a control unit configured to detect red-eye regions in the captured image data that correspond to the current positioning of the one or more viewers.

15. The apparatus of claim 14, wherein the image capture device is aligned with the center of the angular space in the viewing environment

16. The apparatus of claim 14, further comprising:
an infrared (IR) light source configured to emit IR light into the viewing environment,
wherein the image capture device is configured to capture a set of IR image frames while the IR light is emitted.

17. The apparatus of claim 14, wherein the control unit is configured to:
find candidate red-eye regions in the captured image data based on pixel color or intensity;
create an eye signature map of the captured image data identifying each potential pairing of candidate red-eye regions; and
analyze the eye signature map to detect the candidate red-eye regions that correspond to the current positioning of the one or more viewers.

18. The apparatus of claim 17, further comprising:
an image buffer for storing the set of image frames in the captured image data;
a memory unit for storing the eye signature map,
wherein the control unit generates the eye signature map frame by frame based on the captured image data, such that each frame of the eye signature map contains pixel elements demarcating the candidate red-eye regions in the corresponding frame of the captured image data that are part of a potential pairing.

19. The apparatus of claim 18, wherein the control unit includes:
a temporal blink filter for analyzing the eye signature map to detect each potential pairing in which the candidate red-eye regions simultaneously disappear, thereby detecting a pair of red-eye regions corresponding to a particular viewer's left and right eyes, respectively.

20. The apparatus of claim 19, wherein the control unit is further configured to:
generate a map of the angular space in the viewing environment such that, for each detected pair of red-eye regions, the map is segmented into:
a first segment corresponding to the angular region of the viewing environment in which the particular viewer's right eye is positioned, and
a second segment corresponding to the angular region of the viewing environment in which the particular viewer's left eye is positioned.

21. The apparatus of claim 20, further comprising:
a display driver for driving an operation of the image display panel in accordance with the generated map.
